(19) United States
(12) Patent Application Publication
(10) Pub. No.: US 2025/0316005 A1
(43) Pub. Date: Oct. 9, 2025

(54) IMAGE ACQUISITION DEVICE, IMAGE ACQUISITION METHOD, PROGRAM, AND RECORDING MEDIUM

(71) Applicant: FUJIFILM Corporation, Tokyo (JP)

(72) Inventors: Kei YAMAJI, Saitama-shi (JP); Yuya NISHIO, Saitama-shi (JP); Masaru KOBAYASHI, Saitama-shi (JP); Toshiki KOBAYASHI, Saitama-shi (JP)

(73) Assignee: FUJIFILM Corporation, Tokyo (JP)

(21) Appl. No.: 19/240,397

(22) Filed: Jun. 17, 2025

Related U.S. Application Data
(63) Continuation of application No. PCT/JP2023/045747, filed on Dec. 20, 2023.

(30) Foreign Application Priority Data
Jan. 31, 2023 (JP) 2023-012502

(51) Int. Cl. G06T 11/60; G06T 7/73

(52) U.S. Cl. CPC G06T 11/60; G06T 7/74; G06T 2200/24; G06T 2207/20081; G06T 2207/30196

(57) ABSTRACT

An object of the present invention is to provide an image acquisition device, an image acquisition method, a program, and a recording medium for appropriately acquiring a second image based on a first image.

An image acquisition device for acquiring a second image based on a first image includes a processor, in which the processor is configured to execute a process of acquiring first information related to a feature of an image, a process of acquiring second information based on the first information and the first image, and a process of acquiring the second image based on the second information.

### CROSS-REFERENCE TO RELATED APPLICATIONS

This application is a Continuation of PCT International Application No. PCT/JP2023/045747 filed on Dec. 20, 2023, which claims priority under 35 U.S.C. §119(a) to Japanese Patent Application No. 2023-012502 filed on Jan. 31, 2023. The above applications are hereby expressly incorporated by reference, in their entirety, into the present application.

### BACKGROUND OF THE INVENTION

### 1. Field of the Invention

An embodiment of the present invention relates to an image acquisition device, an image acquisition method, a program, and a recording medium that acquire a second image different from a first image based on the first image.

### 2. Description of the Related Art

In some cases, another image is acquired from an original image (hereinafter, also referred to as a first image) using an image processing technique. In addition, in some cases, a second image having a different painting style and impression from the first image is acquired based on the first image. An image display control method described in JP2013-211052A is given as an example of the above.

The image display control method described in JP2013-211052A is a technique that converts an image (corresponding to the first image) captured by a camera into a painterly image (corresponding to the second image). The use of this technique makes it possible to acquire an illustration, a painting, a computer graphics (CG) image, or an image of a virtual space, such as a metaverse, from a captured image of a real space.

### SUMMARY OF THE INVENTION

In general, it is difficult to acquire the second image having a different painting style and impression from the first image based on the first image as in JP2013-211052A. In particular, in a case where the second image as the virtual image is acquired, using the captured image of the real space as the first image, there are many information items to be set, such as image acquisition conditions. In a case where sufficient information is not obtained, there is a concern that the second image will not be appropriately acquired. In addition, it is preferable that various types of second images can be acquired from the first image regardless of the type of the first image (for example, whether the first image is a captured image or a painterly image).

An embodiment of the present invention is to solve the problems of the related art, and an object of the embodiment is to provide an image acquisition device, an image acquisition method, a program, and a recording medium for appropriately acquiring a second image based on a first image.

The above object is achieved by an image acquisition device according to any one of [1] to described below.

[1] There is provided an image acquisition device for acquiring a second image based on a first image, the image acquisition device comprising a processor, in which the processor is configured to execute: a process of acquiring first information related to a feature of an image; a process of acquiring second information based on the first information and the first image; and a process of acquiring the second image based on the second information.

[2] In the image acquisition device according to [1], the second information is information for determining a configuration of the second image.

[3] In the image acquisition device according to [2], the second information includes skeleton information of a target object included in the second image, composition of the second image, or an image acquisition condition based on information related to an atmosphere of the second image.

[4] In the image acquisition device according to any one of [1] to [3], the processor is configured to, in the process of acquiring the second image, acquire the second image based on the second information and the first image.

[5] In the image acquisition device according to [4], the processor is configured to, in the process of acquiring the second image, acquire the second image from the first image based on the second information.

[6] In the image acquisition device according to any one of [1] to [5], the first information is a reference image including the feature of the image.

[7] In the image acquisition device according to [6], the processor is configured to, in the process of acquiring the second information, acquire the second information corresponding to an element, which corresponds to the reference image, in the first image.

[8] In the image acquisition device according to [6] or [7], the reference image is an image that has an atmosphere as a feature and that is selected by a user.

[9] In the image acquisition device according to [6] or [7], the reference image is an image that is selected based on a learning model obtained by machine learning related to a user's preference.

[10] In the image acquisition device according to any one of [1] to [9], the processor is configured to, in the process of acquiring the second information, receive an input operation of a user and acquire the second information corresponding to the input operation.

[11] In the image acquisition device according to any one of [1] to [10], the processor is configured to, in the process of acquiring the first information, analyze the first image and acquire the first information based on an analysis result of the first image.

[12] In the image acquisition device according to any one of [1] to [11], the processor is configured to, in the process of acquiring the second information, analyze the first image and acquire the second information based on an analysis result of the first image.

[13] In the image acquisition device according to any one of [6] to [9], the processor is configured to, in the process of acquiring the second information, analyze both the first image and the reference image and acquire the second information based on analysis results of both the first image and the reference image.

[14] In the image acquisition device according to any one of [1] to [13], the processor is configured to further execute a process of giving information related to at least one of the first image or the second image to the second image.

[15] In the image acquisition device according to any one of [1] to [14], the processor is configured to further execute a process of giving information related to at least one of the first image or the second image to the first image.

[16] In the image acquisition device according to [14], the processor is configured to, in the process of giving the information related to at least one of the first image or the second image to the second image, give a thumbnail image of the first image to the second image.

[17] In the image acquisition device according to [14], the processor is configured to, in the process of giving the information related to at least one of the first image or the second image to the second image, give at least one of the first information or the second information to the second image.

In the image acquisition device according to any one of [1] to [17], the processor is configured to execute a process of setting a priority for each of the first information and the first image, and the processor is configured to, in the process of acquiring the second information, acquire the second information related to a degree of application of each of the first information and the first image in the second image according to the priority.

In addition, according to an embodiment of the present invention, there is provided an image acquisition method for acquiring a second image using a first image, the image acquisition method comprising: a step of causing a processor to acquire first information related to a feature of an image; a step of causing the processor to acquire second information based on the first information and the first image; and a step of causing the processor to acquire the second image based on the second information.

Further, according to an embodiment of the present invention, there is provided a program causing a computer to execute each step included in the above-described image acquisition method.

Furthermore, according to an embodiment of the present invention, there is provided a computer-readable recording medium on which a program causing a computer to execute each step included in the above-described image acquisition method is recorded.

According to an embodiment of the present invention, an image acquisition device, an image acquisition method, a program, and a recording medium for appropriately acquiring a second image based on a first image are achieved.

### BRIEF DESCRIPTION OF THE DRAWINGS

FIG. 1 is a schematic diagram showing a procedure of acquiring a second image based on a first image.

FIG. 2 is a diagram showing a hardware configuration of an image acquisition device according to an embodiment of the present invention.

FIG. 3 is a diagram showing functions of the image acquisition device according to the embodiment of the present invention.

FIG. 4 is a diagram showing an example of information obtained by analyzing an image.

FIG. 5 is a diagram showing an example of a reference image.

FIG. 6 is a diagram showing an example of a menu related to an atmosphere of the second image.

FIG. 7 is a diagram showing an example of accessory information given to the second image.

FIG. 8 is a diagram showing an image acquisition flow according to the embodiment of the present invention.

FIG. 9 is a diagram showing a first specific example in which the second image is acquired using an image acquisition method according to the embodiment of the present invention.

FIG. 10 is a diagram showing a second specific example in which the second image is acquired using the image acquisition method according to the embodiment of the present invention.

FIG. 11 is a diagram showing a third specific example in which the second image is acquired using the image acquisition method according to the embodiment of the present invention.

FIG. 12 is a diagram showing a fourth specific example in which the second image is acquired using the image acquisition method according to the embodiment of the present invention.

FIG. 13 is a diagram showing a fifth specific example in which the second image is acquired using the image acquisition method according to the embodiment of the present invention.

### DESCRIPTION OF THE PREFERRED EMBODIMENTS

A specific embodiment of the present invention will be described. Further, in the following description, there is a case where the description is made in terms of a graphic user interface (GUI) for convenience. In addition, since a basic data processing technique (a communication/transmission technique, a data acquisition technique, a data recording technique, a data processing/analysis technique, an image processing technique, a visualization technique, and the like) for implementing the content thereof is known, a description thereof will be omitted.

Furthermore, in the present specification, the concept of a “device” includes a single device that exhibits a specific function and also includes a combination of a plurality of devices that are distributed, are present independently of each other, and exhibit a specific function in cooperation (operative association) with each other.

Moreover, in the present invention, the term “user” is a user of an image acquisition device according to the present invention and specifically, for example, a person who acquires a second image using the functions of the image acquisition device according to the present invention.

In addition, in the present specification, the term “person” means a main person that performs a specific behavior, can include an individual, a group, a corporation, such as a company, an organization, and the like, and can also further include a computer and a device that constitute artificial intelligence (AI). The artificial intelligence implements intellectual functions, such as inference, prediction, and determination, using hardware resources and software resources. Any artificial intelligence algorithm can be used, and examples thereof include an expert system, case-based reasoning (CBR), a Bayesian network, and a subsumption architecture.

Further, in the present specification, the term “image” means digital data indicating a gradation value of each pixel and is specifically an image data file (image file) generated according to a predetermined format. Furthermore, the image may be a color image, a black-and-white image, or a grayscale image.

In addition, in the present specification, an “element of an image” is an element that is present in the image and specifically means a background and a target object in the image. Further, the “target object” is an element to be recognized and identified among the elements present in the image and specifically means a person or an object other than the background. That is, in a case where the image is a captured image, a person or an object as a subject corresponds to the target object. In a case where the image is a drawn image (an illustration image, a CG image, or the like), a drawn person or object corresponds to the target object.

### <<Outline of Specific Embodiment of the Present Invention>>

One embodiment of the present invention (hereinafter, referred to as the present embodiment) relates to an image acquisition device, an image acquisition method, a program, and a recording medium.

According to the present embodiment, it is possible to acquire a second image based on a first image. An aspect of acquiring the second image based on the first image may include, for example, performing a conversion process on the first image to convert the first image into the second image and newly generating the second image based on information (specifically, first information and second information) based on the first image. In addition, the aspect of acquiring the second image based on the first image may also include projecting some target objects in the first image onto another image and replacing some target objects in the first image with target objects in another image. Further, the aspect of acquiring the second image based on the first image may also include searching for the second image based on information obtained from the first image from the database in which the existing images are accumulated.

The first image is an original image used to acquire the second image and may be a real image representing a real space or a virtual image representing an image that does not exist in reality. The second image is an image having a different atmosphere and impression from the first image and is specifically a virtual image. The atmosphere and impression of the image are visual characteristics of the image, such as the type, painting style, drawing style, and touch of the image.

Examples of the real image may include an image captured in the real space by an imaging device, such as a digital camera, that is, a captured image. Examples of the virtual image may include a painterly image, an image in which a target object has been deformed like a cartoon, an illustration image, a CG image, an image depicting a virtual space, such as a metaverse, and an image depicting a virtual character such as an avatar. In addition, the virtual image may be a two-dimensional (2D) image or a three-dimensional (3D) image.

The second image may be a composite image obtained by combining a portion of the real image with a portion of the virtual image. In addition, the second image may be an image that gives the atmosphere and impression of time and era different from the present time to a location present in the real space, for example, an image representing a past or future image of a certain location. Further, the second image may be an image obtained by making an image of a landscape, a person, or the like drawn as a painting or an illustration close to a real image using CG or the like.

In the present embodiment, for example, the second image as the virtual image can be acquired by changing the subject in the first image, which is the real image, to an avatar or by correcting the pose of the subject. In addition, in the present embodiment, the second image can be acquired by converting the first image, which is a CG image or an illustration image, into a realistic virtual image that gives the impression of a real image.

Further, a known method can be used as an image processing technique for acquiring the second image. For example, in a case where the captured image is converted into a painterly second image, the technique described in JP2004-213598A may be used. Furthermore, AI may be used to generate the second image to have a desired painting style (for example, to reproduce the drawing style of a famous painter).

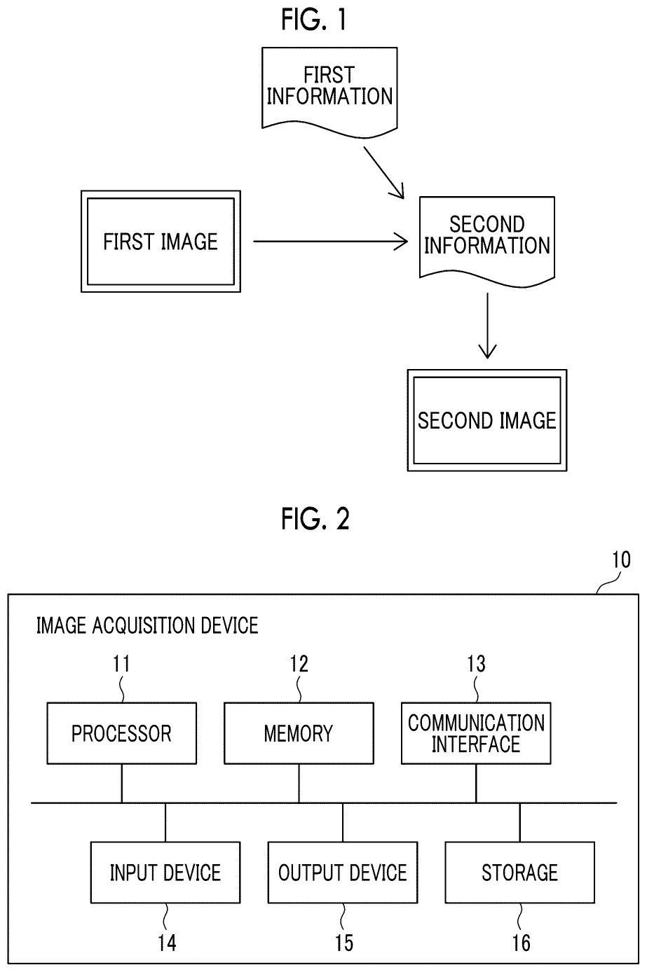

In the present embodiment, a procedure of acquiring the second image based on the first image will be described with reference to FIG. 1. First, the first image and the first information are acquired. A method of acquiring the first image is not particularly limited. For example, communication may be performed with an image providing device (not shown) via a network to acquire the existing image as the first image from the device. Alternatively, the image accumulated in the database or the like may be read out, and the read-out image may be acquired as the first image. In addition, an image captured or drawn by the operation of a client terminal by the user may be received from the client terminal, and the received image may be acquired as the first image.

The first information is information necessary for acquiring the second image and is information related to features of the image. The features of the image are characteristic content and information for specifying the composition of the image, the target object present in the image, the background of the image, and the atmosphere and impression of the image. In addition, for example, the color and image quality (a sense of resolution and resolution), of each portion of the image can also be included in the features of the image. The first information is, for example, information that can be acquired by analyzing the first image, and specific examples of the first information include information related to the skeleton or posture of a person or a character in the first image.

In addition, in a case where label information as accessory information is given to the first image, the label information can be used as the first information. The label information is information indicating the type of each target object in the first image and the position of each target object in the first image. Further, the label information can be given to the image by a known annotation technique.

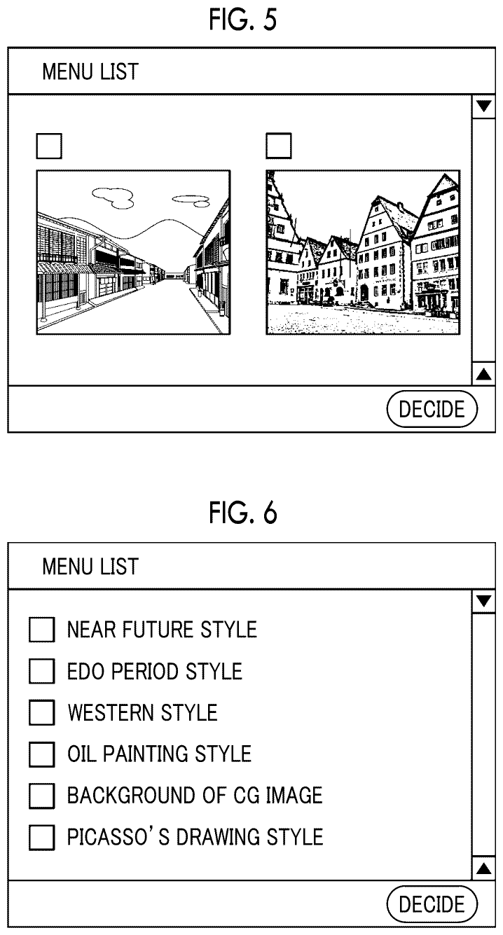

The first information may be acquired by a method other than the analysis of the first image. For example, the first information may be acquired in response to an input operation of the user, specifically, the selection or designation of the first information by the user. Specifically, a list in which a plurality of menus related to the features of the second image are described may be presented to the user, and a menu selected by the user from the list, that is, a selection result of the user related to the content of the features may be acquired as the first information (see FIG. 6). In addition, a plurality of reference images having different atmospheres as the features of the images may be presented to the user, and one or more reference images selected by the user may be acquired as the first information (see FIG. 5).

Then, the second information for determining a configuration of the second image is acquired based on the first image and the first information. The configuration of the second image is content that affects the type, position, and display size of the target object present in the second image, the background of the second image, and the atmosphere of the second image (for example, the impression and painting style of the image).

A method of acquiring the second information is not particularly limited. For example, in a case where the first image is analyzed to acquire the first information, the first information may be corrected or changed to acquire the second information. In this case, the first information may be correct based on an input operation of the user or may be automatically correct based on a preset correction condition.

In addition, in a case where the first information is the reference image, the content specified by comparing both the reference image and the first image, for example, a feature common to both images (specifically, the type of the target object included in both images) may be acquired as the second information. Alternatively, each of the reference image and the first image may be analyzed, and information indicating “which element in the first image is changed and how to change the element” may be acquired as the second information based on the analysis result. Alternatively, information indicating “what kind of image is drawn with what kind of atmosphere” may be acquired as the second information, based on the atmosphere of the reference image and the target object in the first image.

Then, as shown in FIG. 1, the second image is acquired based on the second information. Specifically, for example, the first image may be converted based on the second information to acquire the second image. Specifically, the posture (pose) of a person or a human-shaped avatar in the first image may be changed based on the second information to acquire the second image.

In addition, in a case where the first image is the captured image (real image), the second image may be acquired by converting some or all of the elements in the first image into a CG image or a deformed illustration image based on the second information.

Further, the second image may be acquired by replacing a region corresponding to the second information in the first image with a region in the reference image, which is the first information, or by changing the first image to the atmosphere (painting style) of the reference image.

Furthermore, in a case where the second information indicates what kind of image is drawn with what kind of atmosphere, the second image may be acquired by newly drawing (generating) an image based on the second information. In this case, the second image may be drawn (generated) using the function of artificial intelligence (AI).

In addition, a new second image may be further acquired using the acquired second image as the first image.

### <<Example of Configuration of Image Acquisition Device According to One Embodiment of the Present Invention>>

An image acquisition device (hereinafter, referred to as an image acquisition device 10) according to the present embodiment is used by the user to acquire the second image. The image acquisition device 10 may be a device owned by the user or may be a device installed in a store or the like. The device set in the store or the like corresponds to a terminal, a computer, or the like that is not owned by the user, but can be used by entering a personal identification number, a password, or the like or by making a payment in a case where the user visits the store or the like.

As shown in FIG. 2, the image acquisition device 10 comprises a processor 11, a memory 12, and a communication interface 13. The processor 11 is configured by, for example, a central processing unit (CPU), a graphics processing unit (GPU), a digital signal processor (DSP), or a tensor processing unit (TPU). The memory 12 is configured by, for example, semiconductor memories such as a read only memory (ROM) and a random access memory (RAM). The communication interface 13 is configured by, for example, a network interface card or a communication interface board.

A program (hereinafter, an image acquisition program) causing the processor 11 to acquire the second image is stored in the memory 12. The image acquisition program is a program for causing the processor 11 to perform each step in an image acquisition flow which will be described below. The image acquisition program may be read from a computer-readable recording medium to be acquired or may be downloaded via a communication network, such as the Internet or an intranet, to be acquired.

The image acquisition device 10 can communicate with another device via the communication interface 13 to transmit and receive data to and from the device. In addition, the image acquisition device 10 further comprises an input device 14 and an output device 15 as shown in FIG. 2. The input device 14 includes devices that receive the operation of the user, such as a touch panel and a cursor button. The output device 15 includes a display device such as a display.

Further, the image acquisition device 10 can freely access various types of information stored in a storage 16. The information stored in the storage 16 may include other information necessary for acquiring the reference image as the first information, the first image, and the second image.

Furthermore, the storage 16 may be built in or externally attached to the image acquisition device 10 or may be configured by a network attached storage (NAS) or the like. Alternatively, the storage 16 may be an external device that can communicate with the image acquisition device 10 via the Internet or a mobile communication network, for example, an online storage.

The image acquisition device 10 is directly or indirectly operated by the user to acquire the second image. For example, in a case where the image acquisition device 10 is configured by a user terminal, the user can directly operate the image acquisition device 10 to obtain the second image. In addition, examples of the user terminal constituting the image acquisition device 10 include a personal computer (PC), a smartphone, a tablet terminal, a digital camera having an image editing function, and an image display device such as a display having an image conversion function.

The image acquisition device 10 may be configured by a server computer for an application service provider (ASP), software as a service (SaaS), a platform as a service (PaaS), or an infrastructure as a service (IaaS). In this case, in a case where the user inputs necessary information through a client terminal, the server computer executes a series of information processing related to the acquisition of the second image based on the input information. That is, in the above case, the user can indirectly operate the image acquisition device 10 through the client terminal to obtain the second image.

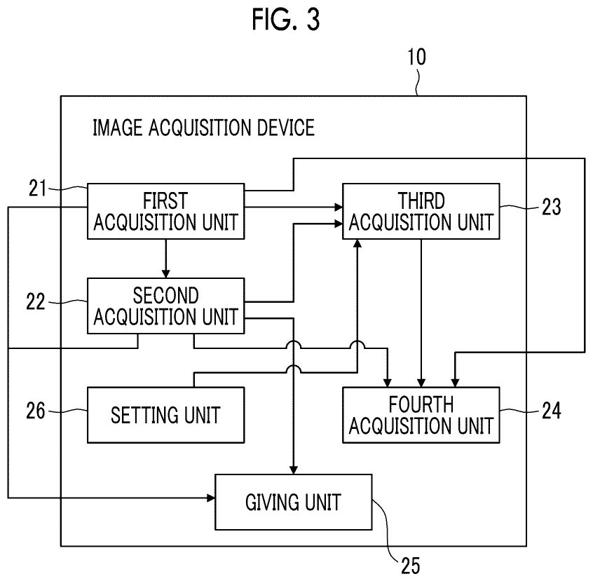

The configuration of the image acquisition device 10 will be described again from the viewpoint of the functions thereof with reference to FIG. 3. As shown in FIG. 3, the image acquisition device 10 includes a first acquisition unit 21, a second acquisition unit 22, a third acquisition unit 23, a fourth acquisition unit 24, a giving unit 25, and a setting unit 26. These functional units are implemented by cooperation between a hardware device of the image acquisition device 10 and software including the above-described image acquisition program. In addition, some of the functions may be implemented using artificial intelligence (AI). Hereinafter, each of the functional units will be described.

### (First Acquisition Unit)

The first acquisition unit 21 acquires the first image. For example, the first acquisition unit 21 may acquire, as the first image, a real image, specifically, an image captured by the user using an imaging device such as a digital camera. A method of acquiring the captured image is not particularly limited. For example, the first image may be acquired by reading the captured image from a memory built in the imaging device or a storage medium that is attachably and detachably connected to the imaging device. In addition, the first image may be acquired by downloading the captured image designated by the user from a database server (not shown) accumulating a large number of captured images.

Further, the first acquisition unit 21 may acquire, as the first image, a CG image, for example, an image (avatar image) showing a human-shaped avatar. In addition, the first acquisition unit 21 may acquire, as the first image, a composite image obtained by combining the real image and the CG image. The composite image may be an image including the background of the real space and the target object drawn by CG or may be an image including the background drawn by CG and a real target object. A method of acquiring the CG image or the composite image is not particularly limited. For example, the first image may be acquired by downloading an image designated by the user from an image providing device (not shown) that provides a ready-made CG image.

Further, in a case where one second image is acquired, the number of first images acquired by the first acquisition unit 21 may be only one or may be two or more.

### (Second Acquisition Unit)

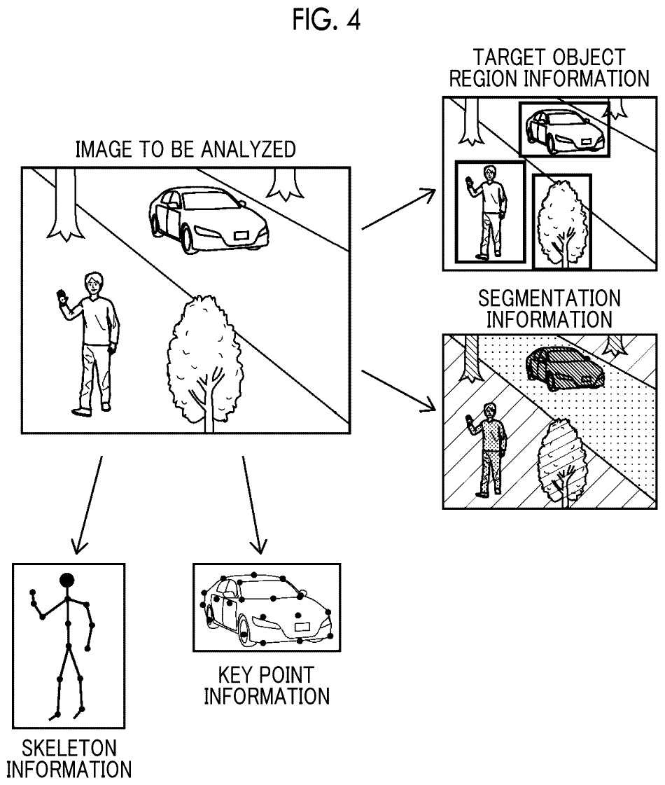

The second acquisition unit 22 acquires the first information related to the configuration of the image. The second acquisition unit 22 may analyze the first image to acquire the first information. Specifically, the second acquisition unit 22 may analyze the first image to calculate a feature amount of each region in the first image. In this case, as shown in FIG. 4, skeleton information of a person or a character in the first image and key point information of a target object in the first image can be acquired as the first information, based on the feature amount of each region in the first image. The skeleton information and the key point information may be acquired using a known image analysis technique.

In addition, the second acquisition unit 22 may acquire, as the first information, information selected by the user for the features of the image. Specifically, as shown in FIG. 5, the second acquisition unit 22 may present a plurality of reference images to the user and acquire one or more reference images selected by the user as the first images. Each reference image is an image in which the feature (specifically, atmosphere) of the image defined by the first information is defined, and the reference images have different features. FIG. 5 shows, as an example, a reference image that gives an atmosphere of Japan in the Edo period and a reference image that gives an atmosphere of Europe in the Middle Ages.

In addition, as shown in FIG. 6, the second acquisition unit 22 may present a list in which a plurality of menus related to the atmosphere of the second image are described to the user and acquire, as the first information, a menu selected by the user from the list. The menu is non-image information and is specifically a phrase or a word representing the atmosphere. In the list shown in FIG. 6, a “near future style”, an “Edo period style”, a “Western style”, an “oil painting style”, a “background of a CG image”, and a “Picasso's drawing style” are shown as examples of the menu.

In addition, in a case where label information related to each target object in the first image is given to the first image, the second acquisition unit 22 may acquire the label information as the first information.

In addition, in a case where one second image is acquired, the number of first information items acquired by the second acquisition unit 22 may be only one or may be two or more.

### (Third Acquisition Unit)

The third acquisition unit 23 acquires the second information for determining the configuration of the second image, based on the first information and the first image. The third acquisition unit 23 may receive an input operation related to the configuration of the second image from the user and acquire the second information corresponding to the input operation. For example, in a case where the skeleton information of the person or the character in the first image is acquired as the first information, the user can perform an input operation of correcting the skeleton information through the input device 14. In this case, the third acquisition unit 23 may change (correct) the skeleton information based on the input operation of the user and acquire the changed skeleton information as the second information.

In addition, the present invention is not limited to this, and the third acquisition unit 23 may automatically correct the first information (for example, the skeleton information) according to a predetermined rule to acquire the second information, regardless of the presence or absence of the input operation of the user.

Further, the third acquisition unit 23 may analyze the first image and acquire the second information, based on the analysis result and the first information. For example, in a case where the reference image selected by the user is acquired as the first information, the third acquisition unit 23 may analyze both the first image and the reference image and acquire the second information related to the composition of the second image, based on the analysis results of both the first image and the reference image.

Specifically, the third acquisition unit 23 analyzes both the first image and the reference image and acquires information of a target object region of each image or segmentation information as the analysis results of both the first image and the reference image. The target object region is a region surrounding the target object in the image and is, for example, a rectangular or circular region as shown in FIG. 4. The segmentation information is information indicating which of the background and the target object an element of each region in the image corresponds to. In a case where the element corresponds to the target object, the segmentation information indicates the type of the target object. It is possible to acquire these information items, based on the feature amount of each region in the image, using a known subject detection technique and a known subject recognition technique.

Then, the third acquisition unit 23 specifies an element corresponding to the reference image in the first image, based on the segmentation information of each of the first image and the reference image, and acquires the second information corresponding to the element. Specifically, the target object common to the reference image may be specified in the first image, and information indicating how to correct (change) the target object may be acquired as the second information. That is, the third acquisition unit 23 may acquire, as the second information, information related to the composition of the second image, specifically, information indicating “which element in the first image is corrected and how to correct the element”.

In addition, the third acquisition unit 23 may analyze both the first image and the reference image and may acquire, as the analysis results, the feature amounts of the entire images and the segmentation information of the images. In this case, the third acquisition unit 23 may specify the atmosphere of the reference image and the target object in the first image, based on the information obtained as the analysis results of both images. The specified items correspond to the information related to the atmosphere of the second image. Then, the third acquisition unit 23 may acquire, as the second information, the image acquisition condition based on the information related to the atmosphere of the second image, specifically, the information indicating “what kind of image is drawn with what kind of atmosphere”.

In addition, in a case where one second image is acquired, the number of second information items acquired by the third acquisition unit 23 may be only one or may be two or more.

### (Fourth Acquisition Unit)

The fourth acquisition unit 24 acquires the second image based on the second information. In the present embodiment, the fourth acquisition unit 24 acquires the second image, based on the second information and the first image and specifically converts the first image into the second image, based on the second information. This will be described using a specific example. In a case where the first image is an image showing an avatar without a background and the second information is the corrected skeleton information, the fourth acquisition unit 24 acquires the second image obtained by correcting the posture (pose) of the avatar in the first image based on the second information. In this case, an image of the avatar whose posture has been changed and another image with a background may be combined, and a composite image (that is, an avatar image with a background) thereof may be acquired as the second image.

In addition, in a case where the first image is the captured image (real image), the fourth acquisition unit 24 may change some or all of the elements in the first image to a CG image, a deformed illustration image, or the like based on the second information to acquire the second image.

Further, in a case where the first image is the captured image and the second information is the information indicating “which element in the first image is changed and how to change the element”, the fourth acquisition unit 24 acquires, as the second image, an image obtained by correcting (converting) the first image based on the second information. Specifically, an image obtained by replacing an element corresponding to the reference image in the first image with an element in the reference image, for example, an image obtained by replacing a person in the first image with a character (avatar) in the reference image, which is a CG image, is acquired as the second image. That is, an image (image piece) of a region corresponding to the second information may be extracted from each of the first image and the reference image, based on the second information, and a composite image obtained by combining the extracted image pieces may be acquired as the second image.

In addition, in a case where the second information is the feature amount of each of the entire first image and the entire reference image, the fourth acquisition unit 24 may acquire the second image by correcting the feature amount of the first image with the feature amount of the reference image such that the atmosphere of the first image approaches the atmosphere of the reference image.

Further, in the present embodiment, the fourth acquisition unit 24 may generate (draw) a new image as the second image based on the second information. Specifically, in a case where the second information is the information indicating “what kind of image is drawn with what kind of atmosphere”, the fourth acquisition unit 24 generates an image, in which the target object indicated by the second information is present, to have the atmosphere (painting style) indicated by the second information. Furthermore, this image drawing function may be implemented by artificial intelligence (AI).

Moreover, the fourth acquisition unit 24 is not limited to the configuration that acquires one second image from one second information item, and may acquire a plurality of second images from one second information item or may acquire one or a plurality of second images from a plurality of second information items.

The second image acquired by the fourth acquisition unit 24 is stored in a state in which the second image can be used by the user. For example, the second image is accumulated in the storage 16 or an external database server and is output to the user through the output device 15. A method of outputting the second image is not particularly limited. For example, the second image may be displayed on the display as the output device 15.

### (Giving Unit)

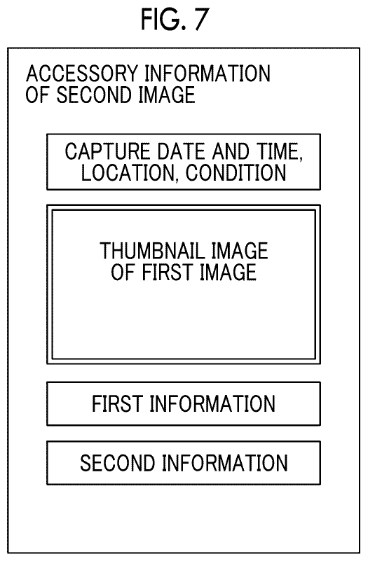

The giving unit 25 gives information related to at least one of the first image or the second image as accessory information of the image to the second image. As shown in FIG. 7, the accessory information may include the thumbnail image of the first image as the information related to the first image. In addition, in a case where the first image is the captured image, the capture date and time, weather, capture location, capture conditions, and the like of the first image may be given as accessory information in an exchangeable image file format (Exif), specifically, tag information. The giving of the accessory information related to the first image to the second image makes it possible to check which first image the second image has been acquired based on. As a result, the user can understand the original image used to acquire the second image after acquiring the second image.

In addition, the accessory information may include the second information used to acquire the second image. In this case, the user can understand what information the second image has been acquired based on, after acquiring the second image. Therefore, in a case where an image (that is, a new second image) having the same atmosphere as the second image is acquired thereafter, it is possible to efficiently acquire the image with reference to the second information as the accessory information. Further, it is possible to reproduce the first image, which is the original image, from the second image and to perform reverse conversion from the second image into the first image, with reference to the second information as the accessory information.

Furthermore, the accessory information may include the first information that is the source of the second information. In this case, the user can understand what information the second image has been acquired based on, strictly speaking, what information has been used as the first information, after acquiring the second image.

Further, the accessory information given to the second image may be at least one of the first information or the second information. In addition, the first information or the second information given as the accessory information to the second image may include at least one of i1 to i6 described below.

i1: Information related to a skeleton or posture of a person or a character in an image

i2: Positional information of a characteristic portion (key point) in the image

i3: Information of a target object region in the image

i4: Identification information (segmentation information) of an element of each region in the image

i5: Label information indicating the type of a target object present in the image and the position of the target object in the image

i6: Information related to a feature amount of the entire image

For i6, the feature amount is information used for image recognition, specifically, a numerical value used for machine learning for recognizing the target object in the image and is information indicating a characteristic tendency in the image.

An aspect of giving the accessory information to the second image may be an aspect of writing the accessory information in the data file of the second image, that is, an aspect of storing the second image and the accessory information in one data file. In addition, an aspect may be adopted in which a data file of the accessory information is generated separately from the second image and a path to the file of the accessory information or an identification ID (for example, a file name or the like) of the file is stored in the data file of the second image. Further, an aspect may be adopted in which a correspondence relationship between the data file of the second image and the data file of the accessory information is stored as another data item, for example, table data.

### (Setting Unit)

In a case where the second information is acquired, the setting unit 26 sets a priority for each of the first information and the first image. Specifically, in a case where the reference image is used as the first information, the setting unit 26 sets a priority for each of the reference image and the first image. The priority reflects the degree of application of each of the reference image and the first image in the second image and is specifically an index value indicating the degree to which the atmosphere of each image is expressed (sensed) in the second image. The setting unit 26 may set the priority for each image based on a setting operation of the user or may automatically set the priority for each image according to a preset criterion.

In a case where the priority is set by the setting unit 26, the third acquisition unit 23 acquires the second information related to the degree of application of each image in the second image according to the set priority. For example, in a case where the image piece extracted from the reference image and the image piece extracted from the first image are combined to acquire the second image, the percentage of each image piece (that is, the occupancy rate of the image piece) in the second image corresponds to the degree of application.

Then, in a case where the second image is acquired based on the second information acquired in the above-described manner, the second image obtained by combining the image piece in the reference image and the image piece in the first image with the degree of application indicated by the second information is acquired. According to this configuration, it is possible to express the atmosphere of the image having a higher priority out of the reference image and the first image in the second image. For example, an image obtained by correcting the element in the first image based on the reference image while maintaining the atmosphere of the first image can be acquired as the second image.

In addition, the priority may be set in units of target object regions (segmentations) in each image. In other words, the priority may be set for each target object (each element) in the image. In this case, for example, the second information is acquired such that the second image obtained by more emphasizing the target object or the background in the first image is obtained.

### <<Example of Operation of Image Acquisition Device According to One Embodiment of the Present Invention>>

Next, an image acquisition flow using the image acquisition device 10 will be described as an example of the operation of the image acquisition device 10 according to the present embodiment. In the image acquisition flow which will be described below, an image acquisition method according to the present invention is used. That is, each step in the image acquisition flow which will be described below corresponds to a component of the image acquisition method according to the present invention.

In addition, the following flow is only an example, and some steps in the flow may be deleted, new steps may be added to the flow, or the execution order of two steps in the flow may be interchanged without departing from the gist of the present embodiment.

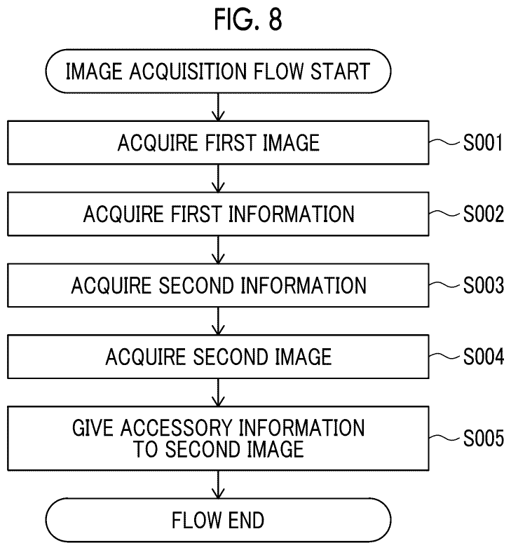

Each step in the image acquisition flow according to the present embodiment is performed by the processor 11 provided in the image acquisition device 10 in the order shown in FIG. 8. In addition, in each step in the image acquisition flow, the processor 11 executes processes corresponding to each step in the data processing defined in the image acquisition program.

In the image acquisition flow according to the present embodiment, first, a step of acquiring the first image is performed (S001). The acquired first image may be a captured image as a real image or may be a virtual image such as a CG image or an illustration image. A method of acquiring the first image and an acquisition source of the first image are not particularly limited. For example, the first image may be acquired by receiving the input of the image captured by the user with a camera.

Then, a step of acquiring the first information related to the features of the image is performed (S002). In this step, the input operation of the user may be received, and the first information corresponding to the input operation may be acquired. For example, a reference image selected by the user or a menu selected by the user from a list of menus related to the atmosphere of the second image may be acquired as the first information. In addition, the first information may be acquired by analyzing the first image. Alternatively, for example, the skeleton information of a person or a character included in the first image may be extracted from the first image and acquired as the first information. Further, the label information given as the accessory information to the first image may be acquired as the first information.

Then, a step of acquiring the second information for determining the configuration of the second image based on the first information and the first image is performed (S003). In this step, an input operation of the user may be received, and the second information corresponding to the input operation may be acquired. For example, in a case where the skeleton information is acquired as the first information, the skeleton information corrected by the input operation of the user may be acquired as the second information.

In addition, in Step S003, the first image may be analyzed, and the second information may be acquired based on the analysis result. More specifically, in a case where the reference image is acquired as the first information, both the first image and the reference image may be analyzed, and the second information may be acquired based on the analysis results of both images. In this case, the element corresponding to the reference image in the first image, for example, the target object common to the first image and the reference image may be specified, and information related to how to change the target object in the first image may be acquired as the second information.

In addition, in a stage before the second information is acquired, the priority may be set for each of the first image and the reference image, which is not particularly shown in FIG. 8. In this case, in Step S003, the second information related to the degree of application of each of the reference image and the first image in the second image may be acquired according to the priority of each image.

Then, a step of acquiring the second image based on the second information is performed (S004). In this step, the second image may be acquired based on the second information and the first image. Specifically, the first image may be converted based on the second information to acquire the second image. For example, the second image may be acquired by replacing some elements of the first image with elements in the reference image or by changing the target object (subject) in the first image, which is the captured image, to a CG image or a deformed illustration image.

In addition, in a case where the second information related to the degree of application of each image in the second image is acquired according to the priority of each of the reference image and the first image, in Step S004, the second image may be acquired by applying (specifically, combining) the reference image and the first image according to the degree of application of each of the images.

Further, in Step S004, instead of converting the first image into another image to obtain the second image, a new image may be generated based on the second information, and the generated image may be acquired as the second image.

Then, a step of giving the accessory information to the acquired second image is performed (S005). In this step, the accessory information related to at least one of the first image or the second image is given to the second image. The accessory information may include, for example, the thumbnail image of the first image. In addition, in a case where the first image is the captured image, the capture date and time, weather, capture location, capture conditions, and the like of the first image may be given as the accessory information. In addition, the accessory information may include at least one of the first information or the second information.

The image acquisition flow is ended at the time when the above-described series of steps is completed. As described above, in the image acquisition flow according to the present embodiment, the first image and the first information are acquired, the second information is acquired based on the first image and the first information, and the second image is acquired based on the second information. Therefore, it is possible to appropriately acquire the second image based on the first image.

Specifically, for example, in a case where the virtual image (second image) obtained by changing the atmosphere of the real image (first image) is acquired using the real image, it is necessary to set the image acquisition conditions or the like or to acquire information defining the conditions. In particular, in a case where an image obtained by deforming some subjects in the real image is acquired as the second image, the size and shape of the subjects are significantly changed. Therefore, information defining the change conditions is required. In addition, in a case where the content of the second image is determined in detail, a larger amount of information is required.

However, in the image acquisition method according to the related art, there are few cases where information necessary for acquiring the second image can be obtained. In a case where this information is acquired, it is necessary to perform a complicated operation in order to set the image acquisition conditions. Then, in a case where the above information is not sufficiently obtained, it is difficult to acquire the second image corresponding to the request of the user.

In contrast, in the present embodiment, it is possible to appropriately and easily acquire the first information, the first image, and the second information as information necessary for acquiring the second image. As a result, it is possible to relatively easily acquire the desired second image. In other words, in the present embodiment, it is possible to intuitively execute the process of acquiring the image (second image) requested by the user.

In addition, in the present embodiment, the first image can be analyzed to acquire the first information. Further, the second information can be acquired by analyzing the first image or by receiving an input operation of the user. Furthermore, in a case in which the reference image is acquired as the first information, both the first image and the reference image can be analyzed to acquire the second information. Therefore, information (specifically, the first information and the second information) defining various conditions can be obtained as the information necessary for acquiring the second image. In addition, in the present embodiment, the first information and the second information can be automatically acquired by the image analysis function of the image acquisition device 10. Therefore, it is possible to more easily acquire these types of information.

### <<Examples of Use of the Present Embodiment>>

Next, some specific cases (cases 1 to 4) will be described as an example in which the second image is acquired using the image acquisition method according to the present embodiment. Further, in the following description, an image T1 corresponds to the first image, an image T2 corresponds to the second image, an image T3 corresponds to the reference image, and an image T4 corresponds to the other image (material image).

### (Case 1)

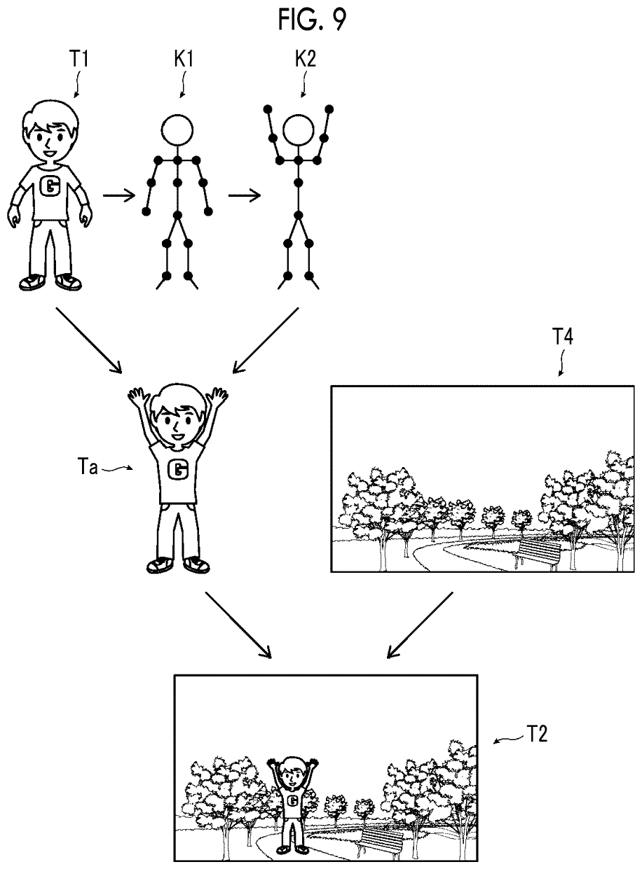

In case 1, the image T2 obtained by converting the image T1 showing only an avatar without a background is acquired. Specifically, as shown in FIG. 9, the image T2 obtained by changing the posture (pose) of the avatar shown in the image T1 is acquired.

A procedure of acquiring the image T2 in case 1 will be described with reference to FIG. 9. The image T1 is analyzed to acquire skeleton information K1 of the avatar. The skeleton information K1 corresponds to the first information and defines the posture of the avatar in the image T1. Then, the skeleton information is corrected based on a correction operation of the user or according to a preset condition to acquire corrected skeleton information K2. The corrected skeleton information K2 corresponds to the second information and defines a posture (pose) different from that in the original skeleton information K1.

Then, the image T1 is converted based on the corrected skeleton information K2. Specifically, the posture of the avatar is corrected to a posture corresponding to the corrected skeleton information K2. Therefore, as shown in FIG. 9, an avatar image Ta in which the posture has been corrected is obtained. Further, the avatar image Ta and the image T4 showing only the background are combined. As a result, the image T2, which is an avatar image with a background, is acquired.

### (Case 2)

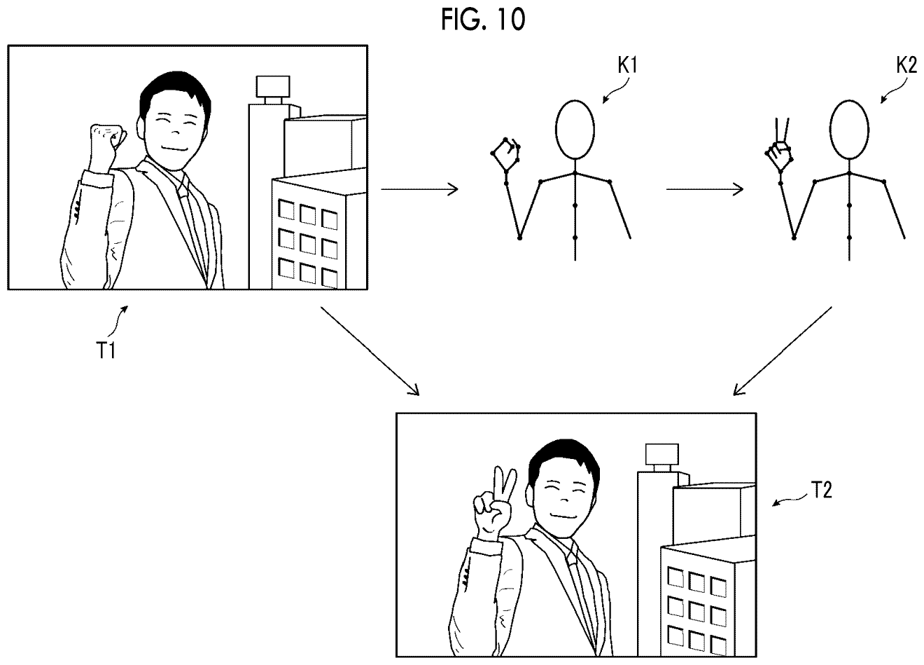

In case 2, a captured image including a person as the subject (target object) is used as the image T1, and the image T2 obtained by converting the image T1 is acquired. Specifically, as shown in FIG. 10, the image T2 obtained by changing the posture (pose) of the person in the image T1 is acquired.

A procedure of acquiring the image T2 in case 2 will be described with reference to FIG. 10. The image T1 is analyzed to acquire skeleton information K1 of the person. The skeleton information K1 corresponds to the first information and defines the posture of the person in the image T1. Then, the skeleton information is corrected based on a correction operation of the user or according to a preset condition to acquire corrected skeleton information K2. The corrected skeleton information K2 corresponds to the second information and defines a posture different from that in the original skeleton information K1. In FIG. 10, the skeleton information K1 represents a skeleton in a case where the shape of the hand is a fist, and the corrected skeleton information K2 represents a skeleton in a case where the shape of the hand is a V-shape.

Then, the image T1 is converted based on the corrected skeleton information K2. Specifically, the shape of the hand of the person who is the subject is corrected to a shape corresponding to the corrected skeleton information K2. Therefore, as shown in FIG. 10, the image T2 in which the posture (hand shape) has been corrected from the image T1 and the other elements are the same as those in the image T1 is acquired.

### (Case 3)

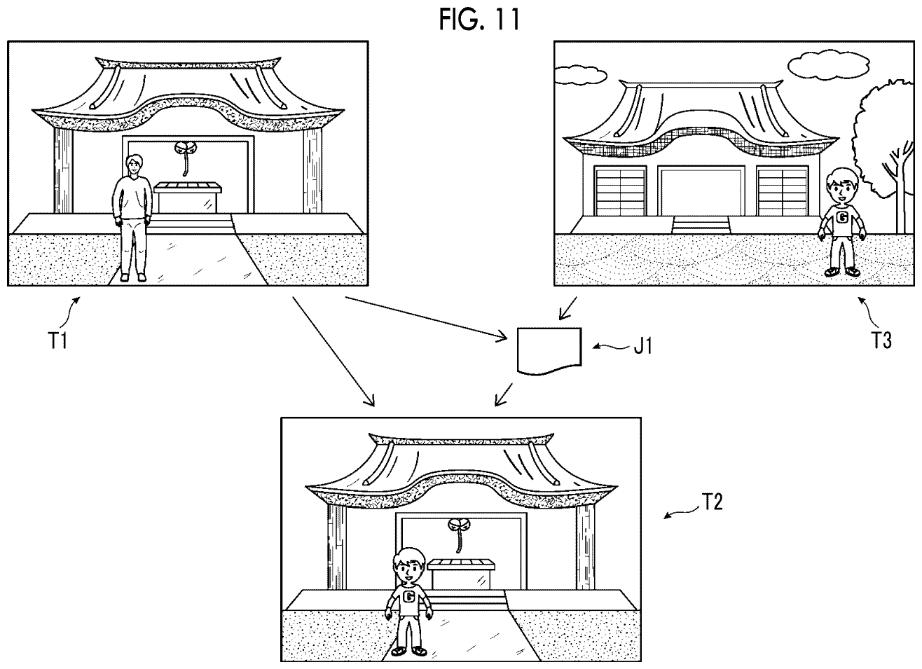

In case 3, a captured image including a person and a building as the subjects (target objects) is used as the image T1. In addition, in case 3, a plurality of reference images are presented to the user, and the image T3, which is one of the reference images, is selected by the user. The selected image T3 corresponds to the first information and includes the background of the real space and a person (avatar) drawn by CG. In addition, the background of the image T3 includes a building (in the case shown in FIG. 11, a shrine) of the same type as the building included in the image T1. Then, in case 3, the image T1 is converted based on the image T3 to acquire the image T2.

A procedure of acquiring the image T2 in case 3 will be described with reference to FIG. 11. For each of the images T1 and T3, each region in the images is partitioned (segmented) according to the element in the region. In addition, for each of the images T1 and T3, the elements in each region of the images are specified, and segmentation information of each region is acquired from the specified elements. Then, information J1 related to the composition of the second image is acquired based on the segmentation information of each of the images T1 and T3. The information J1 related to the composition of the second image corresponds to the second information, is specifically information indicating “which element in the image T1 is corrected and how to correct the element”, and is more specifically information indicating “which element in the image T1 is replaced with the element in the image T3”. Here, in the image T1, the elements which are candidates for the object to be replaced are elements of the same category that are common to the images T1 and T3 and are a person or a building (shrine) in the example shown in FIG. 11.

Then, the image T1 is converted based on the information J1 related to the composition of the second image. Specifically, as shown in FIG. 11, the person in the image T1 is replaced with the avatar in the image T3. Here, in a case where the information J1 is information indicating that “the person in the image T1 is replaced with the avatar in the image T3”, the image T2 in which the person in the image T1 has been replaced with the avatar in the image T3 and the other elements are the same as those in the image T1 is acquired as shown in FIG. 11.

### (Another Example of Case 3)

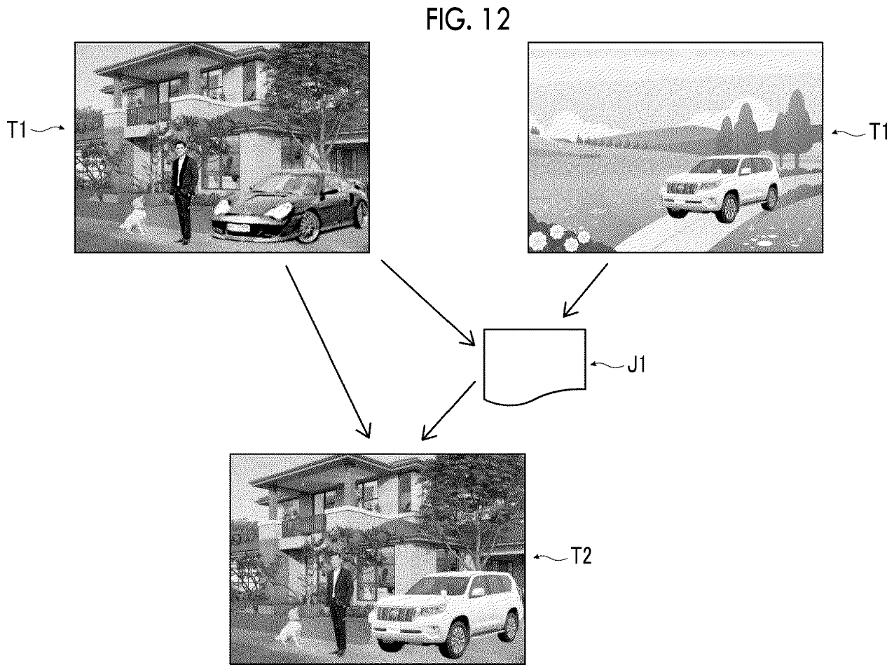

According to the same manner as in case 3, in a case where a captured image in which a plurality of types of subjects including a person are present is used as the image T1, it is possible to acquire the image T2 obtained by replacing some elements in the image T1 with the corresponding elements in the image T3 as shown in FIG. 12.

Specifically, in the example shown in FIG. 12, the image T1 includes a person, a car, a tree, a building, and an animal as the subjects. In addition, the image T3 which is the reference image includes a car, a tree, and a mountain. Among them, only the car is the real image (captured image), and the other elements are drawn by CG.

Further, the segmentation information of each of the images T1 and T3 is acquired by the same procedure as described above, and the information J1 related to the composition of the second image is acquired based on the acquired segmentation information. The information J1 related to the composition of the second image is information indicating “which element in the image T1 is corrected and how to correct the element” and is specifically information indicating “which element in the image T1 is replaced with the element in the image T3”. For example, among the elements in the image T1, elements that are also present in the image T3 correspond to the candidates for the object to be replaced. In the example shown in FIG. 12, the car and the tree correspond to the candidates for the object to be replaced.

Then, the image T1 is converted based on the information J1 related to the composition of the second image. Specifically, at least one (that is, the car or the tree) of the candidates for the object to be replaced in the image T1 is replaced with the element in the image T3. Here, in a case where the information J1 is information indicating that “the car in the image T1 is replaced with the car in the image T3”, the image T2 in which the car in the image T1 has been replaced with the car in the image T3 and the other elements are the same as those in the image T1 is acquired as shown in FIG. 12.

Further, in a case where the information J1 is information indicating that “the tree in the image T1 is changed to a CG image as in the image T3”, the image T2 obtained by changing the tree in the image T1 to the CG image is acquired, which is not particularly shown.

### (Case 4)

In case 4, a captured image of a landscape (for example, a captured image of the sea) is used as the image T1. In addition, in case 4, a plurality of reference images are presented to the user, and the image T3, which is one of the reference images, is selected by the user. The selected image T3 corresponds to the first information and is a painterly image (for example, an image of a Japanese town in the Edo period). Then, in case 4, a new image T2 is generated based on the images T1 and T3.

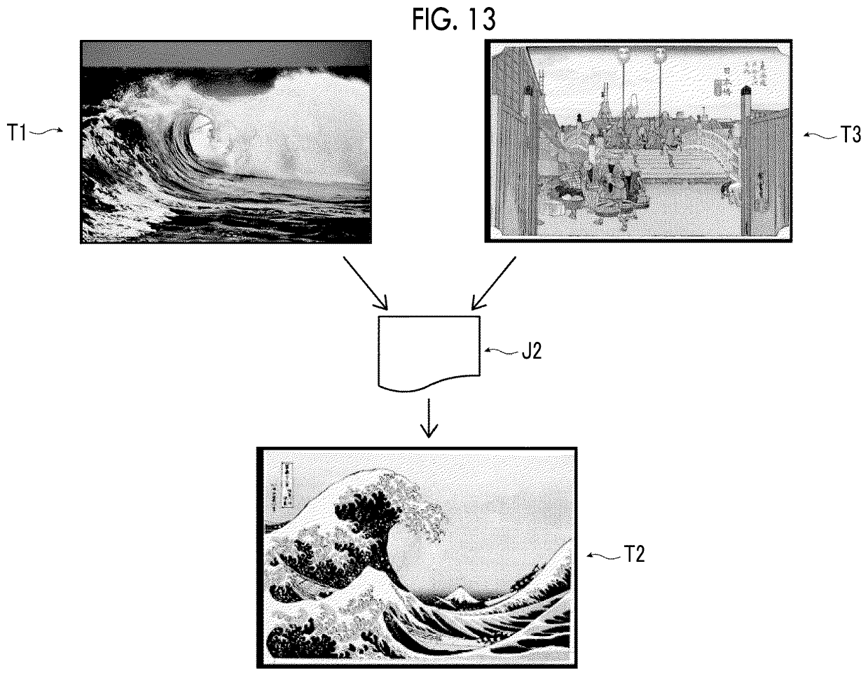

A procedure of acquiring the image T2 in case 4 will be described with reference to FIG. 13. Both the images T1 and T3 are analyzed, and the atmosphere of the image T3 and elements of each region in the image T1 are specified based on the analysis results. Then, an image acquisition condition J2 based on information related to the atmosphere of the second image is obtained from the specified items. The image acquisition condition J2 corresponds to the second information and is specifically information indicating “what kind of image is drawn with what kind of atmosphere”. In the case shown in FIG. 13, the image acquisition condition J2 for drawing the image of the sea to create the atmosphere of the Edo period (for example, to create the drawing style of Hokusai Katsushika) is obtained.

Then, the image T2 is drawn based on the image acquisition condition J2 using artificial intelligence (AI) or the like. Therefore, as shown in FIG. 13, the image T2 in which the element (the sea in FIG. 13) in the image T1 has been drawn to have the atmosphere of the image T3 is acquired.

### <<Other Embodiments>>

The specific embodiment of the present invention has been described above. However, the above-described embodiment is only an example given to facilitate understanding of the present invention and is not intended to limit the present invention. That is, the present invention may be changed or improved from the embodiments described below without departing from the gist of the present invention. Further, the present invention includes its equivalents. Furthermore, the embodiment of the present invention can include combinations of the above-described embodiment and one or more of the following modification examples.

### (First Image and Second Image)

In the above-described embodiment, the first image and the second image are mainly still images. However, the present invention is not limited thereto, and the first image and the second image may be a video, that is, two or more consecutive frame images. In this case, the number of frame images used as the first images and the number of frame images used as the second images acquired based on the first images may be the same or different from each other. In addition, any one of the first image or the second image may be a still image, and the other may be a video.

### (Selection of Reference Image)

In the above-described embodiment, a plurality of reference images are presented to the user, and a reference image selected by the user is used as the first information. However, the present invention is not limited thereto. The user's preference may be estimated by artificial intelligence (AI), and the reference image used as the first information may be automatically selected based on the estimated user's preference. That is, the reference image may be an image selected based on a learning model obtained by machine learning related to the user's preference. The machine learning related to the user's preference is performed in order to specify a tendency of the feature amount of the reference image selected by the user in the past.

### (Giving of Accessory Information)

In the above-described embodiment, the information related to at least one of the first image or the second image is given as the accessory information of the image to the second image. However, the same accessory information may also be given to the first image. For example, the thumbnail image of the second image may be given to the first image. In addition, at least one of the first information or the second information may be given as the accessory information to the first image.

### (For Configuration of Processor)

The processor provided in the image acquisition device according to the present invention includes various processors. The various processors include, for example, a CPU which is a general-purpose processor that executes software (program) to function as various processing units.

Moreover, the various processors include a programmable logic device (PLD) which is a processor whose circuit configuration can be changed after manufacturing, such as a field programmable gate array (FPGA).

Furthermore, the various processors include a dedicated electric circuit which is a processor having a dedicated circuit configuration designed to execute a specific process, such as an application specific integrated circuit (ASIC).

In addition, one functional unit of the image acquisition device according to the present invention may be configured by one of the various processors described above. Alternatively, one functional unit of the image acquisition device according to the present invention may be configured by a combination of two or more processors of the same type or different types, for example, a combination of a plurality of FPGAs, a combination of an FPGA and a CPU, or the like.

Further, a plurality of functional units of the image acquisition device according to the present invention may be configured by one of the various processors, or two or more of the plurality of functional units may be collectively configured by one processor.

Furthermore, a form may be adopted in which one processor is configured by a combination of one or more CPUs and software and the processor functions as a plurality of functional units as in the above-described embodiment.

Further, for example, as represented by a system on chip (SoC) or the like, a form may be adopted in which a processor that implements the functions of the entire system including the plurality of functional units of the image acquisition device according to the present invention using one integrated circuit (IC) chip is used. Furthermore, a hardware configuration of the various processors described above may be an electric circuit (circuitry) in which circuit elements, such as semiconductor elements, are combined.

### EXPLANATION OF REFERENCES

10: image acquisition device

11: processor

12: memory

13: communication interface

14: input device

15: output device

16: storage

21: first acquisition unit

22: second acquisition unit

23: third acquisition unit

24: fourth acquisition unit

25: giving unit

26: output unit

J1: information related to composition of second image

J2: image acquisition condition

K1: skeleton information

K2: corrected skeleton information

T1, T2, T3, T4: image

What is claimed is:

1. An image acquisition device for acquiring a second image based on a first image, the image acquisition device comprising:
a processor,
wherein the processor is configured to execute:
a process of acquiring first information related to a feature of an image;
a process of acquiring second information based on the first information and the first image; and
a process of acquiring the second image based on the second information.

2. The image acquisition device according to claim 1,
wherein the second information is information for determining a configuration of the second image.

3. The image acquisition device according to claim 2,
wherein the second information includes skeleton information of a target object included in the second image, composition of the second image, or an image acquisition condition based on information related to an atmosphere of the second image.

4. The image acquisition device according to claim 1,
wherein the processor is configured to, in the process of acquiring the second image, acquire the second image based on the second information and the first image.

5. The image acquisition device according to claim 4,
wherein the processor is configured to, in the process of acquiring the second image, acquire the second image from the first image based on the second information.

6. The image acquisition device according to claim 1,
wherein the first information is a reference image including the feature of the image.

7. The image acquisition device according to claim 6,
wherein the processor is configured to, in the process of acquiring the second information, acquire the second information corresponding to an element, which corresponds to the reference image, in the first image.

8. The image acquisition device according to claim 6,
wherein the reference image is an image that has an atmosphere as a feature and that is selected by a user.

9. The image acquisition device according to claim 6,
wherein the reference image is an image that is selected based on a learning model obtained by machine learning related to a user's preference.

10. The image acquisition device according to claim 1,
wherein the processor is configured to, in the process of acquiring the second information, receive an input operation of a user and to acquire the second information corresponding to the input operation.

11. The image acquisition device according to claim 1,
wherein the processor is configured to, in the process of acquiring the first information, analyze the first image and acquire the first information based on an analysis result of the first image.

12. The image acquisition device according to claim 1,
wherein the processor is configured to, in the process of acquiring the second information, analyze the first image and acquire the second information based on an analysis result of the first image.

13. The image acquisition device according to claim 6,
wherein the processor is configured to, in the process of acquiring the second information, analyze both the first image and the reference image and acquire the second information based on analysis results of both the first image and the reference image.

14. The image acquisition device according to claim 1,
wherein the processor is configured to further execute a process of giving information related to at least one of the first image or the second image to the second image.

15. The image acquisition device according to claim 1,
wherein the processor is configured to further execute a process of giving information related to at least one of the first image or the second image to the first image.

16. The image acquisition device according to claim 14,
wherein the processor is configured to, in the process of giving the information related to at least one of the first image or the second image to the second image, give a thumbnail image of the first image to the second image.

17. The image acquisition device according to claim 14,
wherein the processor is configured to, in the process of giving the information related to at least one of the first image or the second image to the second image, give at least one of the first information or the second information to the second image.

18. The image acquisition device according to claim 1,
wherein the processor is configured to execute a process of setting a priority for each of the first information and the first image, and
the processor is configured to, in the process of acquiring the second information, acquire the second information related to a degree of application of each of the first information and the first image in the second image according to the priority.

19. An image acquisition method for acquiring a second image using a first image, the image acquisition method comprising:
a step of causing a processor to acquire first information related to a feature of an image;
a step of causing the processor to acquire second information based on the first information and the first image; and
a step of causing the processor to acquire the second image based on the second information.

20. A computer-readable recording medium on which a program causing a computer to execute each step included in the image acquisition method according to claim 19 is recorded.
